(19) United States
(12) Patent Application Publication
(10) Pub. No.: US 2003/0129409 A1
(43) Pub. Date: Jul. 10, 2003

(54) Particle and liquid adhesion reduction coating in polycarbonate sheet

(75) Inventor: Augustina Martina Tacke-Willemsen, Bergen op Zoom (NL)

Correspondence Address: Robert E. Walter, GE Plastics, One Plastics Avenue, Pittsfield, MA, 01201, US

(73) Assignee: General Electric Company

(21) Appl. No.: 10/265,510

(22) Filed: Oct. 4, 2002

Related U.S. Application Data
(60) Provisional application No. 60/344,266, filed on Dec. 27, 2001.

(51) Int. Cl. B32B 27/36

(52) U.S. Cl. 428/412; 428/423.1

(57) ABSTRACT

A substrate having the outer surface facing the atmosphere a coating composition having a silicone modified acrylate polymer additive sufficient to allow ease of removing solid particles (dirt) and/or liquids on the surface by reducing the adhesion of such particles and/or liquids to the substrate. The coating composition may also have in combination therewith an ultra violet absorber and/or a mar resistant coating along with a polymer matrix such as an acrylate polymer and a solvent such as methoxypropanol. The amount of silicone modifier acrylate polymer may range from about 0.5 to about 6.0 weight % based on the total weight of the coating composition. A preferred ultra violet absorber is a polybenzoylresorcinol. The preferred substrate is a transparent aromatic polycarbonate resin sheet or multiwall polycarbonate at least two polycarbonate sheets having interdisposed therebetween and joining said sheets a structure of essentially any configuration.

### CROSS-REFERENCE TO RELATED APPLICATIONS

This application is related to and claims priority from Provisional Application No. 60/344,266 filed on Dec. 27, 2001, the entire contents of which are incorporated

### FIELD OF THE INVENTION

This invention relates to a substrate having coating containing an additive that reduces the adhesion of particles and/or liquid to the surface thereby in effect repelling such materials. The substrate is preferably an aromatic polycarbonate sheet or a multi wall polycarbonate sheet that is utilized in glazing applications but is also applicable for opal white or bronze thermoplastic sheet. The coating may also have, in conjunction therewith, a UV resistant, and/or a mar resistant additive.

### BACKGROUND OF THE INVENTION

For buildings in certain areas, there is a definite need for easy self-cleaning properties for thermoplastic glazing, particularly polycarbonate clear sheets used in glazing applications. Easy self-cleaning is important in order to maintain high light transmission properties of the clear polycarbonate sheet and to minimize build up of unwanted materials on the surface of the polycarbonate substrate or sheet. This would also dramatically lower the frequency of cleaning roofing or glazing in buildings, covered walkways, conservatories and the like. This would also be advantageous for decorative thermoplastic sheet such as opal white or bronze thermoplastic sheet.

Therefore, the instant invention is directed to a novel coating system for substrates, particularly thermoplastic sheets, and more particularly polycarbonate sheets, utilized in glazing applications wherein the coating system greatly reduces the adhesion of liquids and/or solid particles (dirt) to the surface of the thermoplastic sheet thereby making the sheet easily cleanable by washing.

### SUMMARY OF THE INVENTION

The coating systems of the instant invention may be employed in combination with UV protective coatings as well as primers for hardcoat or mar resistant coatings such as silicone hardcoats which contain colloidal silica.

The coating system of this invention contains a novel polyacrylate which is preferably compatible with a UV protective coating and/or a mar resistant coating. The coating system preferably comprises a UV protective coating, a mar resistant or hardcoat in addition to the novel liquid and solid particle adhesion reduction polyacrylate additive. The coating system may be applied to such substrates as metal, painted surfaces, glass, ceramics, thermoplastic sheets and the like. However, the preferred substrate is a thermoplastic sheet and preferably a clear polycarbonate sheet or polycarbonate multiwalled sheet comprising at least two polycarbonate sheets having interposed therebetween a thermoplastic corrugation or web or the like structure separating but joining the at least two polycarbonate sheets. Preferably, the thermoplastic sheet has a high light transmission and the adhesion reduction coating is applied as a separate coating but preferably in combination with a UV resistant protective coating and/or a mar resistant coating. If the coatings are applied separately, the UV protective coating may be employed as a primer for a silicone hardcoat coating.

While many different UV additives may be employed in the practice of one aspect of this invention, a preferred UV protective coating is disclosed in U.S. Pat. No. 5,869,185 and a preferred hard coat is disclosed in U.S. Pat. No. 4,373,061 the disclosures of which are incorporated herein by reference. The preferred UV absorber that may be employed herein as disclosed in U.S. Pat. No. 5,869,185 is a polybenzoylresorcinal such as 4,6-di-(4′-t-butylbenzoyl) resorcinol or 4,6-dibenzolyl-2-propylresorcinol. The hard coat is preferably a colloidal silica silicone.

### BRIEF DESCRIPTION OF THE DRAWING

FIGS. 1A and 1B are photographs showing a control polycarbonate sample sheet (LTC-Lexan Thermoclear) FIG. 1A and a polycarbonate sheet with the adhesion reducing coating FIG. 1B after staining the surfaces of both samples with red pigment material and then cleaning with water.

FIGS. 2A and 2B are photographs of a control polycarbonate sheet LTC and polycarbonate sheet with the adhesion reducing coating 2B both treated with oil as applied and after one minute.

FIG. 3 shows the contact angle of a drop of water on a control polycarbonate sheet LTC.

FIG. 4 shows the contact angle of drop of water on polycarbonate sheet with the adhesion reducing coating thereon.

### DETAILED DESCRIPTION OF THE INVENTION

The instant invention is directed to a coating to be applied to a substrate, preferably a thermoplastic sheet and more particularly a polycarbonate sheet which is preferably a clear polycarbonate sheet or a multiwalled polycarbonate sheet wherein at least two sheets having interdisposed therebetween a structure joining the least two sheets. The interdisposed structure may be for instance a thermoplastic corrugation, a web, a diamond shape structure or the like. The structure may be of the same or different thermoplastic resin than the thermoplastic sheets having said structure interdisposed therebetween.

As stated previously, the adhesion reducing additive of this invention, which may also be referred to as a repellant to liquids and solid particles (dirt), is a silicone modified polyacrylate that is compatible with any UV absorber such as a polybenzoyl resorcinol as well as preferably being compatible with any mar resistant coating, if employed. The coating may have in combination with the adhesion reducing additive (the silicone-modified polyacrylate), a UV resistant additive and/or a mar resistant coating. Each coating composition may be applied as a separate coating wherein each coating is either cured or dried first before any subsequent coating is applied. If separate coatings are applied, it is preferred that the adhesion reducing coating be applied last such that it is the outermost coating. Preferably, however, all three ingredients are incorporated into one coating thus avoiding the additional steps with applying separate coatings.

The reduced adhesion additive may be employed in concentrations and in particular in concentrations that would not effect the excellent light transmission of a transparent or clear thermoplastic substrate while still providing reduced adhesion or repellant properties. Generally, the light transmission of a clear thermoplastic sheet is between 64 to 84% and higher depending on the thickness of the thermoplastic substrate. Preferably, the concentration of the silicone modified polyacrylate is about 0.5 to about 5.0% by weight based on the total weight of the coating to be applied to the thermoplastic substrate. While not intending to be bound by this theory, the self cleaning effect of the repellent is known as the Lotus effect which is based on the self cleaning ability of a Lotus flower to cleanse itself of dirt and/or water due to the surface roughness caused by different microstructures together with hydrophobic properties of the chemical substances in the microlayer of the Lotus flower. Thus the adhesion of water and particles is greatly reduced.

The adhesion reduced additive or repellant is a silicone modified polyacrylate that is compatible with the UV resistant additive; the UV resistant additive is described above and is preferably a polybenzoyl resorcinol. The repellant of this invention should preferably be compatible with any mar resistant or hard coat employed in the practice of this invention. Any UV resistant additive and the repellant should preferably be employed with a transparent polymer matrix such as an acrylate or methacrylate polymer or copolymer thereof as a binder for the additives in combination with a solvent such as methoxy propanol. Therefore, the coating composition may comprise the novel repellant of this invention, a UV resistant additive and/or a mar resistant additive all in combination with an acrylate base polymer matrix and a solvent.

The polymer matrix is present in an amount of about 10 to about 30% by weight based on the total weight of the coating composition. The UV resistant additive may range from about 2 to about 6% by weight based on the total weight of the coating composition. The additives may vary in the amounts set forth above providing the amounts employed are compatible and do not substantially effect the light transmission of the transparent thermoplastic substrate if employed as a substrate and preferably not below about 50% light transmission. However, when the substrate is not clear or transparent, light transmission is not important but the coating may obscure any decorative property of the substrate.

Compatible or compatibility, as used throughout this application, is defined as meaning a composition wherein phase separation of the additives from the polymer matrix is not prominent. The transparent polymer matrices should be compatible with the UV resistant additive particularly the polybenzoylresorcinol described herein and in U.S. Pat. No. 5,869,185. Examples of the transparent polymer matrices that may be employed herein beside an acrylate or methacrylate polymer include polyurethanes, polycarbonates, polystyrenes, or copolymers as well as mixtures thereof. As used herein, acrylate polymers may be defined as acrylates, methacrylates as well as copolymers and mixtures thereof. Included in the term polymer matrix are compositions that typically and preferably comprise acrylate polymers and an organic solvent as well as emulsions of acrylate polymers and water and acrylate polymer compositions in water. When an organic solvent is employed, it should be of the type that dissolves the acrylate polymer, is inert towards the substrate particularly a thermoplastic substrate, and which organic solvent is readily volatized. Some nonlimiting examples of such solvents include hydroxyethers, alcohols, beta alcohols, liquid aliphatic hydrocarbons and mixtures thereof. A preferred organic solvent is methoxy propanol.

If a mar resistant additive is employed, there is no limitation of the type of mar resistant additive other than it adhere to the coating/primer. However, a preferred mar resistant additive is a colloidal silica silicone hardcoat. The UV resistant additive particularly the polybenzoylresorcinols also are primers for silicone hardcoats.

The substrate employed in the practice of this invention may be any substrate such as painted surfaces, glass, ceramics, opaque or clear thermoplastic substrates such as opal white, bronze or transparent substrates. In one embodiment, the substrate is a thermoplastic substrate. In another embodiment, the substrate is selected from not limited thereto, the group of, carbonate homopolymers; polyester carbonate copolymers obtained from the reaction product of a dihydroxy phenol, a carbonate precursor and a dicarboylic acid such as terephthalic and/or isophthalic acid; blends of polycarbonate with other polymers; acrylates; methacrylates and copolymers; styrene polymers; polysulfones, mixtures thereof; and the like.

The thermoplastic substrate may be a single sheet or a laminated sheet of at least two sheets or a polycarbonate composite multiwalled glazing sheet known as Lexan Thermoclear, manufactured and sold by General Electric Company's Plastics component. The preferred substrate is a polycarbonate resin sheet or a polycarbonate composite or Lexan Thermoclear (LTC). LTC is a multiwall polycarbonate transparent sheet extruded from polycarbonate resin and comprises at least two polycarbonate sheets having interdisposed and joining said sheets a structure that may be a web, corrugation, diamond or just rib configuration. The polycarbonate resin is an aromatic carbonate homopolymer made up of recurring aryl polycarbonate units of the formula:

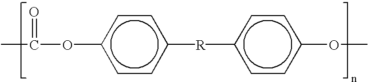

wherein R is a divalent hydrocarbon radical containing from 1-15 carbon atoms and n is an integer of from about 20 to about 150. The polycarbonate is obtained by the reaction of an aromatic dihydroxy compound with a carbonate precursor such as a carbonyl chloride or a daryl carbonate or the like. A preferred aromatic dihydroxy compound is 2,2- bis(4-hydroxy phenyl) propane also commonly known as Bisphenol-A.

### EXAMPLES

The following Examples are provided merely to show one skilled in the art how to apply the principals of this invention as discussed herein. The Examples are not intended to limit the scope of the claims appended to this invention.

### Example 1

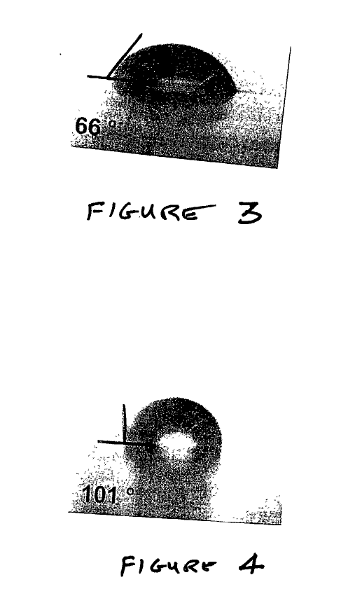

Polycarbonate multiwall sheets namely Lexan Thermoclear were coated with just a UV resistant protective coating 4,6-dibenzoylresorcinol as a control sample (4.5% by weight) and a LTC sheet coated with the same UV resistant coating having added to the coating composition the adhesion reducing additive (AR) of the invention. The amount of UV resistant additive employed was about 4.5% by weight and about 2% by weight of the adhesion reducing additive, namely a silicone modified polyacrylate. The coating composition also contained in combination about 20% by weight of poly methyl methacrylate polymer matrix with the balance being about 73.5% by weight of methoxy propanol solvent. The weight percents are based on the total weight of the coating composition. With each specimen, the contact angle of a drop of the specimen was measured as shown in FIGS. 3 and 4. The results obtained are set forth in the following Table 1.

TABLE 1

| | Contact Angle | Contact Angle Adhesion |
|---|---|---|
| Test Liquid | Control | Reducing Additive |
| Water | 66° | 101 |
| Glycerin | 40° | 101 |
| Ethyleneglycol | 50° | 91 |
| 1-Octanol | 13° | 18 |
| M-Dodecane | 10° | 12 |

As shown by the test results in Table 1, the addition of the adhesion reducing additive greatly increases the contact angle of a bead of the liquid with the surface of the substrate. The greater the angle of contact, the less is the adhesion of the liquid to the substrate surface, and thus easier to remove with water or washing. Please note FIGS. 3 and 4 which shows the contact angle of a bead of liquid with respect to the control sample and a sample of the additive of the instant invention.

### Example 2

The samples prepared in Example 1, namely the Control sample and the sample of this invention were measured for surface tension, disperse part and polar part. The results obtained were as follows:

TABLE 2

| | Surface | | |
|---|---|---|---|
| Sample | Tension N/m | Disperse Part* | Polar Part* |
| Control | 38.2 | 20.7 | 17.5 |
| Adhesion Reducing | 21.9 | 21.5 | 0.4 |
| Additive | | | |

m N/m means-milli newton/meter

*Corresponding with the basic interaction forces, the Adhesion energy can be divided in a polar part and a disperse part. First part is based on London forces also known as van der Waals force and occurs on every interface between liquid, gas and solid surfaces. For the second part, polar molecules are needed. The surface energy can also be divided into a disperse and a polar part: sigma (i)=sigma (i) dispers+sigma (i) polar. In order to calculate both parts seperately the assumption is made that various disperse surface energies add up to one part of disperse adhesion energy and for polar part. Adhesion energy means the energy which is needed to remove for instance the liquid droplet from the solid substrate. This is dependent on the contact angle, the lower the contact angle the higher the adhesion energy and the higher the contact angle the lower the adhesion energy.

The results show that the surface tension of the liquid bead was significantly lower than the control sample, further demonstrating that the tendacity of the liquid to the substrate surface is greatly reduced. A higher dispersed part and a lower polar part is wanted for lower surface tension thereby again demonstrating that the liquid is easier to remove from the substrate surface due to lower surface tension.

### Example 3

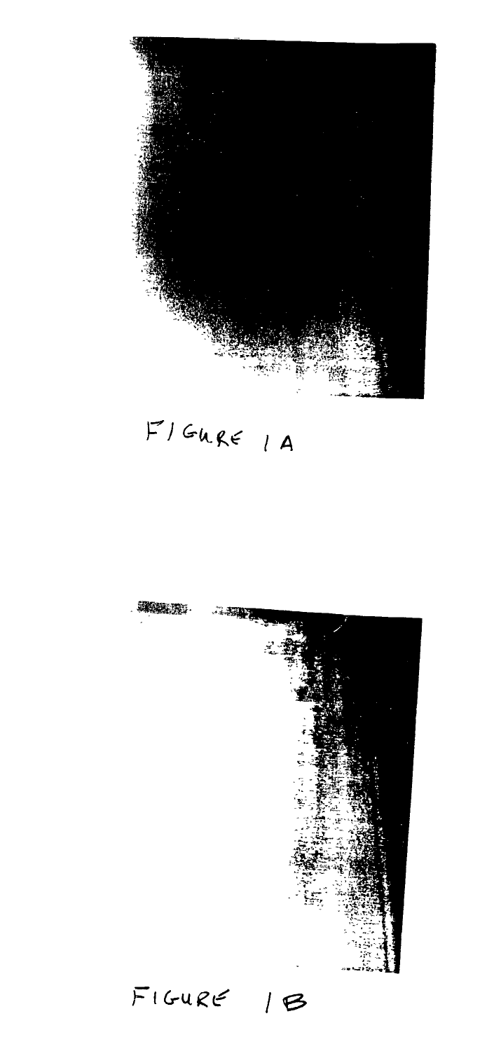

Lexan Thermoclear substrate samples without and with a coating of the repellent of this invention were stained with a red pigment build up. The samples were then cleaned with water. The results are shown in FIGS. 1A and 1B, wherein the red pigment build up is easily removed with water from the sample having a coating containing the adhesion reducing additive of this invention.

### Example 4

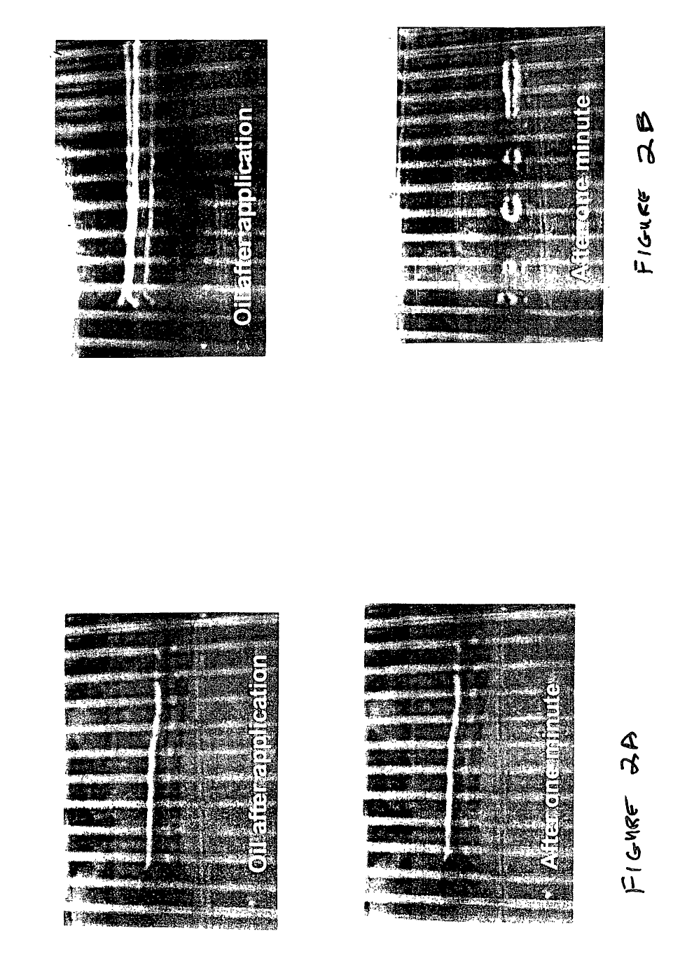

Lexan Thermoclear substrate sample is coated with the repellent of this invention. Oil is placed on the surface of the sample. Oil is also placed on a control sample having no coating. The results are shown in FIGS. 2A and 2B wherein after 1 minute the oil has not dissipated on the control sample while on the coated sample employing the repellent of this invention, the oil is almost repelled after 1 minute.

Although this invention has been described by reference to particular illustrated embodiments thereof, many variations and modifications of this invention may become apparent to those skilled in the art without departing from the spirit and scope of this invention as set forth in the appended claims hereto.

What is claimed is:

1. A substrate having on an outer surface facing the atmosphere a coating composition comprised of a silicone modified acrylate polymer repelling additive in an amount sufficient to allow ease of removing solid particles and liquids on said surface by reducing the adhesion of such particles and liquids to the substrate.

2. The coating composition of claim 1 wherein the composition comprises about 0.5 weight % to about 6.0 weight % of the repelling additive based on the total weight of the coating composition.

3. The coating composition of claim 1 further comprising an ultra violet light resistant additive in an amount sufficient to absorb ultra violet light.

4. The composition of claim 3 wherein the amount of the ultra violet light additive present in the coating composition is about 0.5 to about 10.0 percent by weight based on the total weight of this coating composition.

5. The coating composition of claim 3 wherein the coating composition comprises a polymer matrix selected from the group consisting of polyurethanes, polycarbonates and copolymer thereof, polystyrene and copolymers thereof, acrylate and methacrylate polymers and copolymers thereof, and mixtures thereof and wherein the ultra violet light additive is polybenzoyl resorcinol providing that said ultra violet additive is compatible with the silicone modified acrylate polymer repelling additive and that the coating composition is transparent.

6. The composition of claim 5 further comprising an organic solvent for the polymer matrix.

7. The composition of claim 6 wherein the organic solvent is selected from the group consisting of hydroxyethers, alcohols, keto alcohols, liquid aliphatic hydrocarbons, liquid cyclialiphatic hydrocarbons, and mixtures thereof.

8. The coating composition of claim 7 wherein the solvent is methoxy propanol.

9. The coating composition of claim 1 further comprising a mar resistant additive.

10. The coating composition of claim 9 wherein the mar resistant coating is a colloidal silica silicone hard coat additive.

11. The composition of claim 1 wherein the substrate is selected from the group consisting of a painted surface, glass, ceramic and thermoplastic.

12. The composition of claim 11 wherein the thermoplastic is an aromatic polycarbonate sheet.

13. The composition of claim 12 wherein the thermoplastic aromatic polycarbonate sheet is a multiwalled composite consisting essentially of at least two therebetween a structure joining the at least two polycarbonate sheets and wherein the multiwalled composite is transparent.
